(19) United States
(12) Patent Application Publication
(10) Pub. No.: US 2005/0092582 A1
(43) Pub. Date: May 5, 2005

(54) Staggering drum

(75) Inventors: Thomas Meins, Labenz (DE); Michael Nurnberg, Lauenburg/Elbe (DE); Ilmar Jonat, Hamburg (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/968,982

(22) Filed: Oct. 21, 2004

(30) Foreign Application Priority Data
Oct. 30, 2003 (DE) 103 51 070.2

(51) Int. Cl. B65G 47/91

(52) U.S. Cl. 198/471.1

(57) ABSTRACT

Staggering drum for conveying rod-shaped articles of the tobacco processing industry arranged in at least two rows next to one another. The staggering drum includes at least one conveyor disk with seats for a row of articles, and at least one of the seats includes at least two suction bores structured and arranged to be coupled to a vacuum. At least one of the at least two suction bores being not disconnectable from the vacuum in a transport area of the articles. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 103 51 070.2, filed on Oct. 30, 2003, the disclosure of which is expressly incorporated by reference herein in its entirety.

### BACKGROUND OF THE INVENTION

1. Field of the Invention

The invention relates to a staggering drum for conveying rod-shaped articles of the tobacco processing industry, in particular filter elements, arranged in at least two rows next to one another, including a conveyor disk with seats for a row of articles. Moreover, the invention relates to a machine of the tobacco processing industry, in particular a filter manufacturing machine or filter tipping machine.

2. Discussion of Background Information

In the present context, articles of the tobacco processing industry mean those objects that are held in one or more parallel rows on conveyors, such as, e.g., on conveyor drums in filter or cigarette manufacturing machines and conveyed by them. Such articles are filter cigarettes and filter rods, filter segments, etc. For the sake of simplicity, if only filters or filter elements are referred to below, this also applies accordingly to other articles of the aforementioned type to be conveyed.

The removal of filter plugs, i.e., of rod-shaped articles, from a magazine by means of a magazine drum is described in the printed patent specification DE-C-1 272 795. Filter rods are hereby removed from the magazine and subsequently cut into filter plugs. In order to transfer the filter plugs arranged coaxially and in rows to a fluted drum in a staggered manner, an intermediate conveyer is arranged, whereby the intermediate conveyor has a conveyor disk for each row.

Furthermore, in printed patent specification DE-C-1 173 825 a staggering device for filter rods is described in which two suction air openings are provided at a seat for a filter rod.

### SUMMARY OF THE INVENTION

Accordingly, the present invention provides a staggering drum in which a rapid adjustment to different lengths of filter plugs is possible.

According to the present invention, a staggering drum for conveying rod-shaped articles of the tobacco processing industry, in particular filter elements, arranged in at least two rows next to one another, includes a conveyor disk with seats for a row of articles, in which a seat features at least two suction bores that can be acted on with a vacuum and that the vacuum is not disconnectable at one of the at least two suction bores in the transport area of the filter elements,

The invention provides that filter rods or elements of different lengths are staggered on the staggering drum in the seats of the conveyor disks regardless of their length. In particular, the seats or conveyor disks are hereby embodied or formed in their width or length such that they accept and stagger the maximum to be handled of rod lengths of the articles. In particular, only two rows of articles are staggered on this staggering drum so that in total only two conveyor disks are provided on the drum. According to the invention, the vacuum at one of the at least two suction bores is not disconnectable between the acceptance of the filter elements from a conveyor drum and the transfer to a further conveyor drum during the transport on the staggering drum. Consequently, a vacuum is always applied at a suction bore of a seat in the conveyor area of the filter elements.

Preferably the vacuum can be disconnected at at least one suction bore by a disconnection device so that energy for generating a vacuum is saved according to the length of the articles to be staggered and moreover the suctioning of dirt particles or the like is prevented.

In particular, the vacuum at suction bores of at least two seats is simultaneously disconnectable.

Moreover, it is favorable if the vacuum is simultaneously disconnectable at several suction bores of a conveyor disk.

Moreover, it is advantageous if the vacuum at suction bores of the two conveyor disks is disconnectable independent of one another so that filter rods or rod-shaped articles of different lengths are staggered on the conveyor disks.

In an advantageous embodiment of the invention, each conveyor disk has a disconnection device.

To this end the disconnection device is embodied in an annular and/or adjustable manner.

In particular the disconnection device features disconnection elements for the suction bores so that the vacuum is disconnected for a group of seats or for respectively one seat at a conveyor disk accordingly.

Preferably the disconnection elements are adjustable, so that an adjustment of the disconnection elements, e.g., on a ring, is possible at low expense.

In order to adjust the staggering drum quickly to rod-shaped articles of differing lengths for staggering, the disconnection device is advantageously arranged on the staggering drum in a displaceable manner, so that an adjustment to a different length format of the articles to be conveyed and staggered is possible with a few manipulations.

Furthermore, the invention provides a machine of the tobacco processing industry, in particular, a filter manufacturing machine or a filter tipping machine, that includes a staggering drum according to the invention. Staggering drums are used above all in filter manufacturing machines, e.g., for assembling several filter segments or in filter tipping machines. To avoid repetitions, reference is expressly made to the staggering drum according to the invention described above.

The present invention is directed to a staggering drum for conveying rod-shaped articles of the tobacco processing industry arranged in at least two rows next to one another. The staggering drum includes at least one conveyor disk with seats for a row of articles, and at least one of the seats includes at least two suction bores structured and arranged to be coupled to a vacuum. At least one of the at least two suction bores being not disconnectable from the vacuum in a transport area of the articles.

According to a feature of the invention, the rod-shaped articles may include filter elements.

In accordance with another feature of the present invention, the staggering drum may also include a disconnection device structured and arranged to selectively disconnect at least one of the suction bores from the vacuum.

Further, each seat can include at least two suction bores structured and arranged to be coupled to a vacuum, and at least one of the at least two suction bores is not disconnectable from the vacuum in a transport area of the articles. Suction bores of at least two seats are simultaneously disconnectable from the vacuum.

More than two suction bores of the conveyor disk can be simultaneously disconnectable from the vacuum.

In accordance with still another feature of the invention, the at least one conveyor disk may include at least two conveyor disks, and the suction bores of the at least two conveyor disks can be disconnectable from the vacuum independently of one another. Each conveyor disk can include a disconnection device. The disconnection device can be formed in at least one of an annular and adjustable manner. Further, the disconnection device may include disconnection elements for the suction bores, and the disconnection elements may be adjustable. At least one of the disconnection elements can be structured and arranged in a displaceable manner.

The invention is directed to a machine of the tobacco processing industry comprising the staggering drum as discussed above. Further, the machine may be one of a filter manufacturing machine or filter tipping machine.

The invention is directed to a process for conveying rod-shaped articles of the tobacco processing industry. The process includes arranging the articles in at least two rows next to one another, moving the articles of a row in seats of a conveyor disk, the conveyor disk comprising at least two suction bores coupled to a vacuum, and uninterruptably suctioning through at least one of the at least two suction bores in a transport area of the articles.

In accordance with still yet another feature of the invention, the process may include selectively disconnecting at least one of the at least two suction bores from the vacuum.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a cross section through a staggering drum according to the invention; and

FIG. 2 illustrates a perspective sectional view of the staggering drum depicted in FIG. 1.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

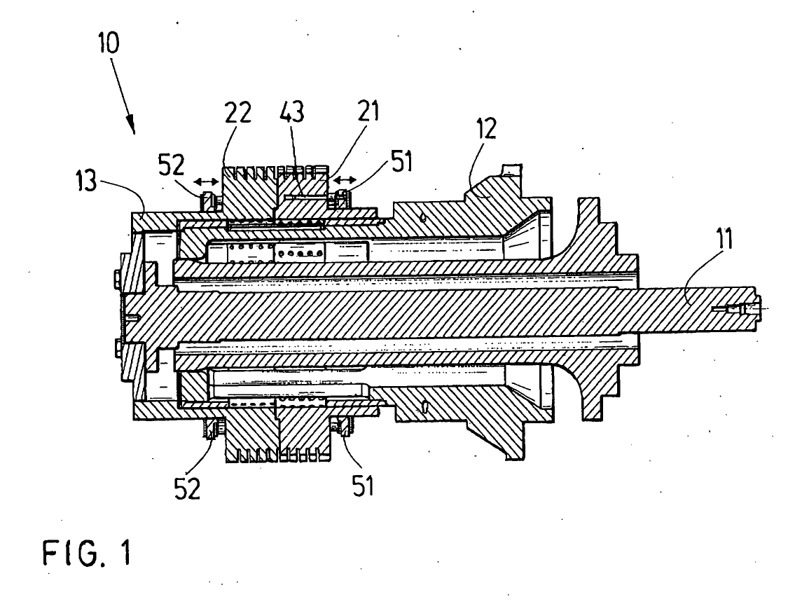

FIG. 1 shows the cross section of a staggering drum 10. The staggering drum 10 has a control flange 12 that is fixedly connected to the machine side. Moreover, a rotating shaft 11 is provided that is supported in a rotary manner and is connected to a drum body 13. Two conveyor disks 21, 22 are arranged on the drum body 13 in order to stagger two rows of rod-shaped articles, e.g., filter rods.

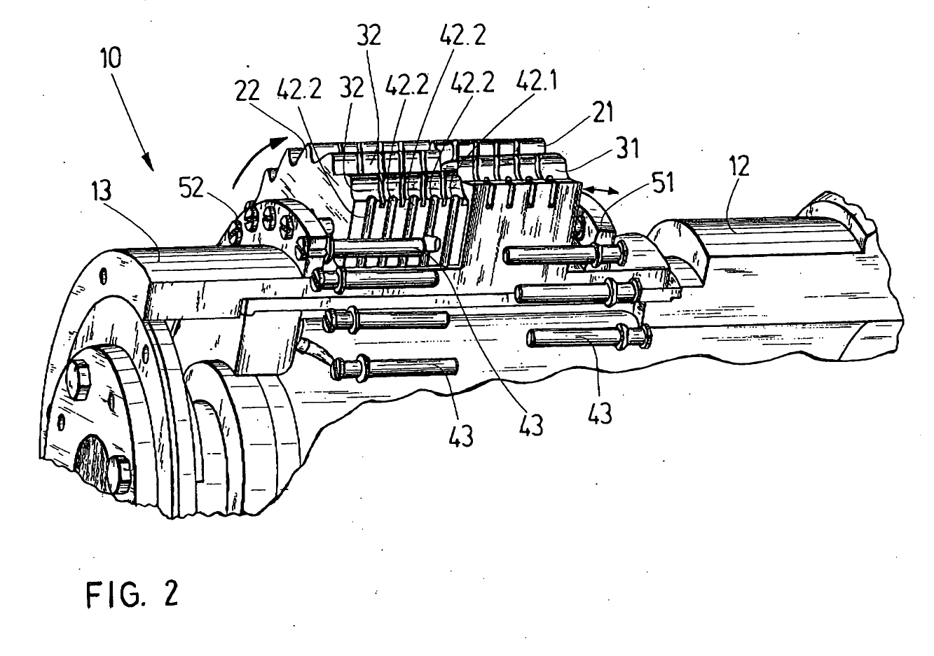

Each conveyor disk 21, 22 has seats 31, 32 (FIG. 2) that are arranged displaced at a radial angle with respect to one another, Each seat 31, 32 has several suction bores 42.1, 42.2 that are arranged next to one another in the axial direction.

By way of example, a seat of a conveyor disk is described in detail below, whereby the following applies in the same manner to the other seats of the other conveyor disk.

In FIG. 2 the seat 32 has a radially arranged suction bore 42.1 and several suction bores 42.2. The suction bore 42.1 is embodied in the conveyor disk 22 such that when a vacuum is applied to the staggering drum 10, a vacuum is always applied via the suction bore 42.1. The vacuum applied to the other suction bores 42.2 can be disconnected by a pin element 43. The pin element 43 and other pin elements are arranged on rings 51, 52 on the drum body 13. Through a longitudinally axial displacement of the rings 51, 52 together with the pins 43 arranged on them, it is possible to disconnect or connect the vacuum applied at the suction bores 42.2. Through this a vacuum is applied to the suction bore 42.1 according to the length of the articles thus conveyed and at other suction bores 42.2 according to the length. According to the invention, a vacuum is always applied at the suction bore 42.1. This vacuum cannot be disconnected. In addition, a vacuum can be connected or disconnected at the suction bores 42.2 as needed. This depends on the length of the filter rods. The width of the seats 31, 32 is designed for the maximum to be handled of rod lengths of a filter or a smoking article, that are processed on the machine. Two rows of articles are staggered flexibly with respect to the longitudinal format by means of the staggering drum 10 according to the invention.

Through the displaceability of the rings 51, 52 together with the pins 43, an adjustment to a new article length can be made very quickly.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

10 Staggering drum

11 Shaft

12 Control flange

13 Drum body

21 Conveyor disk

22 Conveyor disk

31 Seat

32 Seat

42.1 Suction bore

42.2 Suction bore

43 Pin

51 Ring

52 Ring

1. A staggering drum for conveying rod-shaped articles of the tobacco processing industry arranged in at least two rows next to one another, comprising:
at least one conveyor disk with seats for a row of articles;
at least one of said seats comprising at least two suction bores structured and arranged to be coupled to a vacuum, and at least one of said at least two suction bores being not disconnectable from the vacuum in a transport area of the articles.

2. The staggering drum in accordance with claim 1, wherein the rod-shaped articles comprise filter elements.

3. The staggering drum in accordance with claim 1, further comprising a disconnection device structured and arranged to selectively disconnect at least one of said suction bores from the vacuum.

4. The staggering drum in accordance with claim 1, wherein each seat comprises at least two suction bores structured and arranged to be coupled to a vacuum, and at least one of said at least two suction bores being not disconnectable from the vacuum in a transport area of the articles.

5. The staggering drum in accordance with claim 4, wherein suction bores of at least two seats are simultaneously disconnectable from the vacuum.

6. The staggering drum in accordance with claim 1, wherein more than two suction bores of said conveyor disk are simultaneously disconnectable from the vacuum.

7. The staggering drum in accordance with claim 1, wherein said at least one conveyor disk comprises at least two conveyor disks, and said suction bores of the at least two conveyor disks are disconnectable from the vacuum independently of one another.

8. The staggering drum in accordance with claim 7, wherein each conveyor disk comprises a disconnection device.

9. The staggering drum in accordance with claim 8, wherein said disconnection device is formed in at least one of an annular and adjustable manner.

10. The staggering drum in accordance with claim 7, wherein said disconnection device comprises disconnection elements for said suction bores.

11. The staggering drum in accordance with claim 10, wherein said disconnection elements are adjustable.

12. The staggering drum in accordance with claim 10, wherein at least one of said disconnection elements is structured and arranged in a displaceable manner.

13. A machine of the tobacco processing industry comprising the staggering drum in accordance with claim 1.

14. The machine in accordance with claim 13, wherein said machine comprises one of a filter manufacturing machine or filter tipping machine.

15. A process for conveying rod-shaped articles of the tobacco processing industry, comprising:
arranging the articles in at least two rows next to one another;
moving the articles of a row in seats of a conveyor disk, the conveyor disk comprising at least two suction bores coupled to a vacuum;
uninterruptably suctioning through at least one of the at least two suction bores in a transport area of the articles.

16. The process in accordance with claim 15, further comprising selectively disconnecting at least one of the at least two suction bores from the vacuum.
